(19) United States
(12) Patent Application Publication
(10) Pub. No.: US 2022/0003867 A1
(43) Pub. Date: Jan. 6, 2022

(54) INFORMATION PROCESSING SYSTEM, INFORMATION PROCESSING METHOD, AND STORAGE MEDIUM

(71) Applicants: NEC Corporation, Minato-ku, Tokyo (JP); NEC PLATFORMS, LTD., Kawasaki-shi, Kanagawa (JP)

(72) Inventors: Jun UCHIMURA, Tokyo (JP); Hiroshi TAKAHASHI, Kanagawa (JP)

(73) Assignee: NEC Corporation, Minato-ku, Tokyo (JP)

(21) Appl. No.: 17/293,547

(22) PCT Filed: Nov. 13, 2019
(86) PCT No.: PCT/JP2019/044602

§ 371 Date: May 13, 2021

(51) Int. Cl. G01S 17/18; G01S 17/89; G01B 11/02; G01B 11/03

(52) U.S. Cl. CPC G01S 17/18; G01B 11/03; G01B 11/026; G01S 17/89

(57) ABSTRACT

Provided are an information processing system, an information processing method, and a storage medium that can realize high working efficiency in loading of loads. The information processing apparatus includes: a dimension measurement unit that measures three-dimensional dimensions of a load; and an identification information acquisition unit that acquires identification information on the load based on a signal read from the load in measurement of the three-dimensional dimensions.

### TECHNICAL FIELD

The present invention relates to an information processing system, an information processing method, and a storage medium.

### BACKGROUND ART

Patent Literature 1 discloses a handy type terminal apparatus used in collecting loads that optically reads sender information, destination information, a type of the load, or the like from an invoice by scanning the invoice attached to a load. The terminal apparatus used in collecting loads disclosed in Patent Literature 1 emits laser light to an edge of a load, receives reflected light, thereby measures respective lengths required for calculating the volume of the load, and calculates the volume of the load based on respective measurement data.

### CITATION LIST

### Patent Literature

PTL 1: Japanese Patent Application Laid-open No. 2005-029324

### SUMMARY OF INVENTION

### Technical Problem

In the terminal apparatus disclosed in Patent Literature 1, however, not only is manual scanning of an invoice required, but also unloading may be required before the scanning. Thus, in the terminal apparatus disclosed in Patent Literature 1, it is difficult to realize high working efficiency in loading of loads.

In view of the problem described above, the example object of the present invention is to provide an information processing system, an information processing method, and a storage medium that can realize high working efficiency in loading of loads.

### Solution to Problem

According to one example aspect of the present invention, provided is an information processing system including: a dimension measurement unit that measures three-dimensional dimensions of a load; and an identification information acquisition unit that acquires identification information on the load based on a signal read from the load in measurement of the three-dimensional dimensions.

According to another example aspect of the present invention, provided is an information processing method including: measuring three-dimensional dimensions of a load; and acquiring identification information on the load based on a signal read from the load in measurement of the three-dimensional dimensions.

According to yet another example aspect of the present invention, provided is a storage medium storing a program that causes a computer to perform: causing a dimension measurement unit to measure three-dimensional dimensions of a load; and acquiring identification information on the load based on a signal read from the load in measurement of the three-dimensional dimensions.

### Advantageous Effects of Invention

According to the present invention, high working efficiency in loading of loads can be realized.

### BRIEF DESCRIPTION OF DRAWINGS

FIG. 1 is a schematic diagram illustrating a configuration of a loading management system according to a first example embodiment of the present invention.

FIG. 2 is a block diagram illustrating a configuration of the loading management system according to the first example embodiment of the present invention.

FIG. 3 is a schematic diagram illustrating a gate apparatus in the loading management system according to the first example embodiment of the present invention.

FIG. 4 is a flowchart illustrating operations of a gate system and a management server in the loading management system according to the first example embodiment of the present invention.

FIG. 5 is a schematic perspective view illustrating the structure of a ranging apparatus according to a second example embodiment.

FIG. 6 is a schematic front view illustrating the structure of the ranging apparatus according to the second example embodiment.

FIG. 7 is a schematic top view illustrating the structure of the ranging apparatus according to the second example embodiment.

FIG. 8 is a diagram of light paths when a reflective surface is provided through the vertex of a parabola.

FIG. 9 is a diagram of light paths when no reflective surface is provided through the vertex of a parabola.

FIG. 10 is a diagram of light paths when no reflective surface is provided through the vertex of a parabola.

FIG. 11 is a schematic top view illustrating the structure of a ranging apparatus according to a third example embodiment.

FIG. 12 is a schematic top view illustrating the structure of a ranging apparatus according to a fourth example embodiment.

FIG. 13 is a schematic perspective view illustrating the structure of a ranging apparatus according to a fifth example embodiment.

FIG. 14 is a schematic top view illustrating the structure of the ranging apparatus according to the fifth example embodiment.

FIG. 15 is a sectional view of a logarithm spiral reflecting mirror of the ranging apparatus according to the fifth example embodiment.

FIG. 16 is a diagram illustrating reflection of light at a reflective surface forming a logarithm spiral.

FIG. 17 is a schematic front view illustrating the structure of a ranging apparatus according to a sixth example embodiment.

FIG. 18 is a schematic top view illustrating the structure of the ranging apparatus according to the sixth example embodiment.

FIG. 19 is a schematic perspective view illustrating the structure of a ranging apparatus according to a seventh example embodiment.

FIG. 20 is a schematic top view illustrating the structure of the ranging apparatus according to the seventh example embodiment.

FIG. 21 is a schematic perspective view illustrating the structure of a gate apparatus according to an eighth example embodiment.

FIG. 22 is a schematic top view illustrating the arrangement of gate apparatuses according to a ninth example embodiment.

FIG. 23 is a block diagram illustrating a configuration of an information processing system according to another example embodiment.

### DESCRIPTION OF EMBODIMENTS

Exemplary example embodiments of the present invention will be described below with reference to the drawings. Throughout the drawings, the same components or corresponding components are labeled with the same references, and the description thereof may be omitted or simplified.

### First Example Embodiment

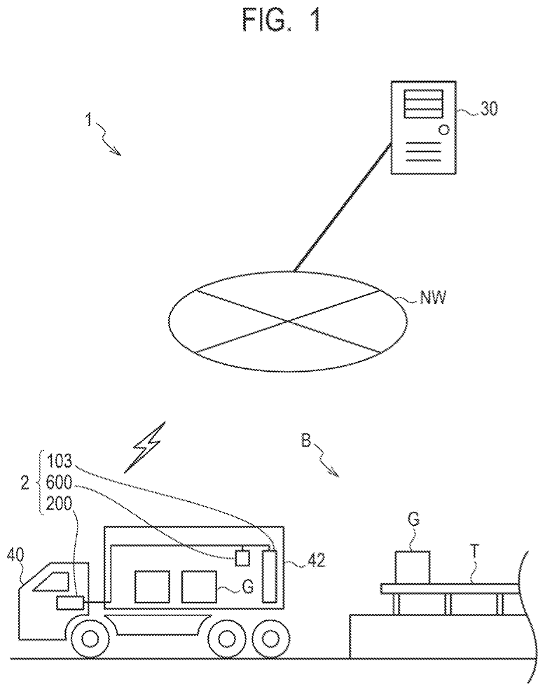

A loading management system according to a first example embodiment of the present invention will be described with reference to FIG. 1 to FIG. 4.

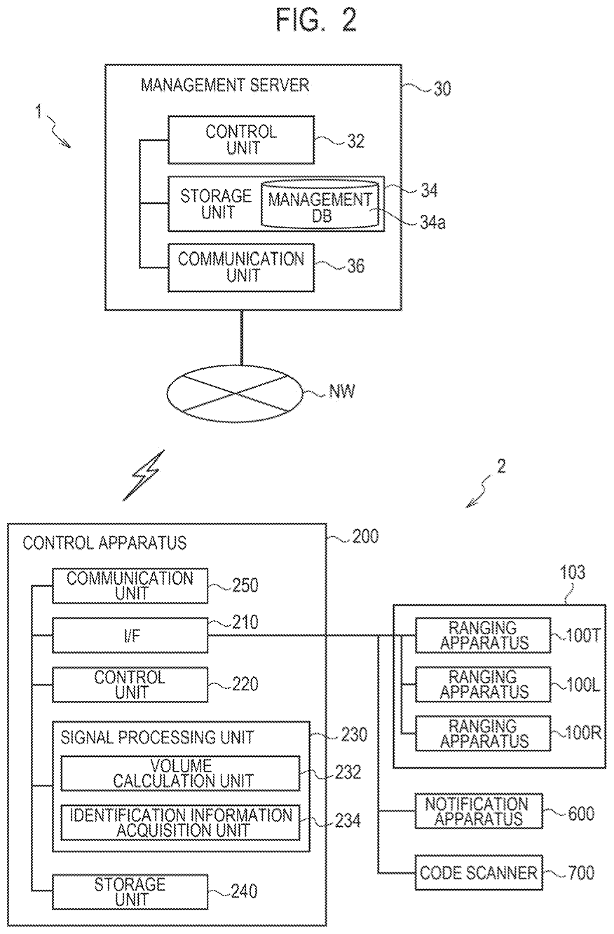

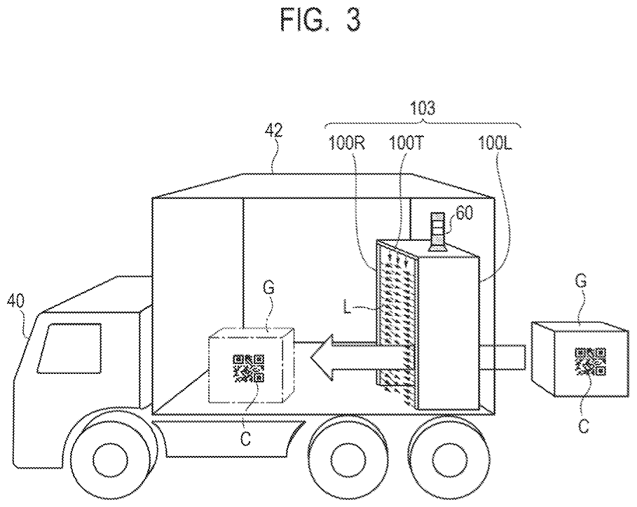

First, the configuration of the loading management system according to the present example embodiment will be described with reference to FIG. 1 to FIG. 3. FIG. 1 is a schematic diagram illustrating the configuration of the loading management system according to the present example embodiment. FIG. 2 is a block diagram illustrating the configuration of the loading management system according to the present example embodiment. FIG. 3 is a schematic diagram illustrating a gate apparatus in the loading management system according to the present example embodiment.

As illustrated in FIG. 1 and FIG. 2, a loading management system 1 according to the present example embodiment includes a gate system 2 and a management server 30. The gate system 2 is mounted on each vehicle 40 such as a truck, for example. The gate system 2 includes a gate apparatus 103, a control apparatus 200, and a notification apparatus 600. The management server 30 is connected to a network NW. The network NW is formed of a Local Area Network (LAN), a Wide Area Network (WAN), a mobile communication network, or the like. The control apparatus 200 of the gate system 2 is able to connect to the network NW in a wireless scheme such as mobile communication, for example. The control apparatus 200 and the management server 30 can communicate with each other via the network NW. Note that the communication scheme of the control apparatus 200 may be suitably selected from a wireless scheme or a wired scheme in accordance with the installation place thereof, for example.

The gate system 2 is an information processing system and is mounted on the vehicle 40. For example, the vehicle 40 is a goods vehicle such as a truck that is loaded with and transports loads G. The gate system 2 may be mounted on a single vehicle 40 or a plurality of vehicles 40. Further, the type of the vehicle 40 is not particularly limited as long as it can be loaded with the load G without being limited to a truck.

Note that the gate apparatus 103, the control apparatus 200, and the notification apparatus 600 included in the gate system 2 are not necessarily required to be mounted on the vehicle 40, respectively. Some or all of the gate apparatus 103, the control apparatus 200, and the notification apparatus 600 may be installed in a vehicle berth B where loads G are loaded into the vehicle 40, for example. This feature will be described in the ninth example embodiment described later.

The vehicle 40 has a cargo space 42 that is a box-shaped load-carrying platform loaded with the load G, for example. The gate apparatus 103 is installed at the loading port such as a rear door, a side door, or the like of the cargo space 42 inside the cargo space 42, for example. The type of the cargo space 42 is not particularly limited and may be, for example, a van body type, a wing body type, a hooded flat body type, a refrigerator type, a freezer type, or the like. The cargo space 42 may be formed of a container used for transporting the load G, such as a shipping container. Note that the vehicle 40 may be a vehicle which has a load-carrying platform of the flat body type having no hood with the top opened instead of the cargo space 42 that accommodates a load inside the space. In such a case, the gate apparatus 103 is installed on the end of a load-carrying platform on the openable gate side that is the side from which the load G is loaded, for example. The vehicle 40 may be any vehicle that has a load-carrying platform that may be loaded with the load G as described above.

Note that the load G loaded in the cargo space 42 of the vehicle 40 is not particularly limited and may be any type of loads. Further, the state of the load G is not particularly limited and may be any state such as a state of being packed with a packing material such as a cardboard box, a state of being accommodated in a shipping container such as a pallet box, a bare state, or the like, for example.

The load G is loaded into the cargo space 42 of the vehicle 40, for example, at the vehicle berth B such as a distribution center. In the vehicle berth B, the load G to be loaded into the vehicle 40 is transported by a transport path T. The gate system 2 is to acquire identification information used for inspection of the load G and measure and acquire the volume of the load G in loading of the load G into the cargo space 42 of the vehicle 40 described above. Note that the place where the load G is loaded into the cargo space 42 may be not particularly limited and may be various places without being limited to the vehicle berth B.

The control apparatus 200 is installed in a cab, a chassis, the cargo space 42, or the like of the vehicle 40, for example. Note that the installation place in the vehicle 40 of the control apparatus 200 is not particularly limited and may be any places. Further, the control apparatus 200 is not necessarily required to be installed in the vehicle 40 and may be installed in a separate place from the vehicle 40, such as a base facility that manages the vehicles 40. In such a case, the control apparatus 200 is configured to be able to communicate with ranging apparatuses 100T, 100L, and 100R in a wireless scheme. Further, in such a case, the control apparatus 200 may be connected to the network NW in a wired scheme.

As illustrated in FIG. 3, the gate apparatus 103 has a ceiling portion, a left side wall portion, and a right side wall portion forming the gate structure through which the load G to be loaded into the vehicle 40 passes. The gate apparatus 103 has ranging apparatuses 100T, 100L, and 100R that function as a ranging unit that acquires distance distribution information on the distance to the load G passing through the gate apparatus 103. The ranging apparatus 100T forms the ceiling portion of the gate apparatus 103. The ranging apparatus 100L forms the left side wall portion of the gate apparatus 103. The ranging apparatus 100R forms the right side wall portion of the gate apparatus 103. The gate apparatus 103 can define the left and the right from a direction in which the load G passes through the gate apparatus 103 and is transported into the cargo space 42. For example, the ranging apparatuses 100T, 100L, and 100R can be installed by being attached to the casing of the gate apparatus 103, respectively. Note that the gate apparatus 103 is not necessarily required to have all the ranging apparatuses 100T, 100L, and 100R, for example, not necessarily required to have the ranging apparatus 100T forming the ceiling portion. Further, a ranging apparatus that acquires distance distribution information on the distance to the load G that passes through the gate apparatus 103 may be installed also on the floor portion of the gate apparatus 103.

Each of the ranging apparatuses 100T, 100L, and 100R is a Light Detection and Ranging (LiDAR) device, for example. Each of the ranging apparatuses 100T, 100L, and 100R can acquire a distribution of distances from the ranging apparatuses 100T, 100L, and 100R to a target object by emitting light in a predetermined range and detecting reflected light from the target object. The ranging apparatuses 100T, 100L, and 100R may be more generally called a sensor device. Note that, in the present specification, light is not limited to visible light and is intended to include light that is unable to be perceived by a naked eye, such as an infrared ray, an ultraviolet ray, or the like. Further, each of the ranging apparatuses 100T, 100L, and 100R is not limited to a LiDAR device and may be any apparatus that can acquire distance distribution information described later, that is, three-dimensional dimensions of the load G.

Specifically, the ranging apparatus 100T emits light to the load G passing under the ranging apparatus 100T from the entire emission surface parallel to the floor surface of the cargo space 42 and detects reflected light from the load G. Thereby, the ranging apparatus 100T can acquire a two-dimensional distribution of distances from the ranging apparatus 100T to the load G across the reference surface parallel to the emission surface.

Further, specifically, the ranging apparatus 100L emits light to the load G passing on the right side of the ranging apparatus 100L in the gate apparatus 103 from the entire emission surface perpendicular to the lateral direction of the gate apparatus 103 and detects reflected light from the load G. Thereby, the ranging apparatus 100L can acquire a two-dimensional distribution of distances from the ranging apparatus 100L to the load G across the reference surface parallel to the emission surface.

Further, specifically, the ranging apparatus 100R emits light to the load G passing on the left side of the ranging apparatus 100R in the gate apparatus 103 from the entire emission surface perpendicular to the lateral direction of the gate apparatus 103 and detects reflected light from the load G. Thereby, the ranging apparatus 100R can acquire a two-dimensional distribution of distances from the ranging apparatus 100R to the load G across the reference surface parallel to the emission surface.

In such a way, the ranging apparatuses 100T, 100L, and 100R in the gate apparatus 103 acquire distance distribution information indicating a distribution of distances to the load G from a plurality of directions different from each other, namely, the direction from the top to the bottom, the direction from the left to the right, and the direction from the right to the left, respectively. Accordingly, the ranging apparatuses 100T, 100L, and 100R function as a dimension measurement unit that measures three-dimensional dimensions of the load G. It is possible to calculate the volume of the load G by using the distance distribution information acquired from a plurality of directions different from each other in such a way, that is, by using the three-dimensional dimensions of the load G. Note that a specific configuration example of the ranging apparatuses 100T, 100L, and 100R will be described in second to eighth example embodiments.

Further, the ranging apparatuses 100T, 100L, and 100R can detect the reflected light described above, respectively, thereby read a code symbol on the load G displayed by printing, attachment, or the like, and output a reading signal that is a signal read from the code symbol. The code symbol includes identification information that identifies the load G, which is not particularly limited, and is a one-dimensional or two-dimensional code symbol such as a barcode, a QR code (registered trademark), or the like, for example. When the load G is loaded into the cargo space 42 of the vehicle 40, the load G is inspected based on a reading signal from a code symbol, which is a signal read from the load G.

The ranging apparatuses 100T, 100L, and 100R can read a code symbol displayed on different surfaces of the load G when acquiring a distribution of distances to the load G, that is, when measuring the three-dimensional dimensions of the load G, respectively. That is, the ranging apparatus 100T can read a code symbol displayed on the top surface of the load G. Further, the ranging apparatus 100L can read a code symbol displayed on the left side surface of the load G. Further, the ranging apparatus 100R can read a code symbol displayed on the right side surface of the load G. When the display position of the code symbol on the load G is identified in advance, it is only necessary that at least one of the ranging apparatuses 100T, 100L, and 100R which corresponds to the display position can read the code symbol.

Note that a code scanner 700 that reads a code symbol displayed on the load G and outputs a reading signal may be installed separately from the ranging apparatuses 100T, 100L, and 100R. The code scanner 700 can be installed so as to read a code symbol displayed on the load G and output a reading signal when the ranging apparatuses 100T, 100L, and 100R acquire a distribution of distances to the load G. As the code scanner 700, a code scanner that supports the type of the code symbol displayed on the load G can be installed. The code scanner 700 is installed at a position where it is possible to read the code symbol of the load G in the gate apparatus 103, for example.

Further, identification information on the load G may be recorded on a Radio Frequency Identification (RFID) tag or an RFID label attached to the load G, for example, instead of a code symbol. In such a case, the gate apparatus 103 may have an RFID reader that reads an RFID tag or an RFID label when the load G passes therethrough. An information carrier that holds identification information on the load G may be any types of carriers in addition to a code symbol, an RFID tag, or the like. In such a case, the gate apparatus 103 may have a reading unit that reads identification information on the load G from an information carrier, such as a scanner, a reader, or the like, in accordance with the type of the information carrier.

The notification apparatus 600 notifies a driver on the vehicle 40, a loading worker, or the like of an inspection result of the load G by using display or sound when the load G is loaded into the cargo space 42 of the vehicle 40. The notification apparatus 600 can notify of an inspection result by using various methods, for example, can turn on a green lamp, a red lamp, or the like of a display lamp in accordance with an inspection result or display an inspection result on a display. Further, the notification apparatus 600 can also notify of an inspection result by issuing a sound such as an alert sound, for example.

The control apparatus 200 is an information processing apparatus such as a computer, for example. As illustrated in FIG. 2, the control apparatus 200 has an interface (I/F) 210, a control unit 220, a signal processing unit 230, a storage unit 240, and a communication unit 250. The interface 210 is a device that connects the control apparatus 200 and the ranging apparatuses 100T, 100L, and 100R to each other and the control apparatus 200 and the notification apparatus 600 to each other in a communicative manner by a wired connection or a wireless connection. Thereby, the control apparatus 200 and the ranging apparatuses 100T, 100L, and 100R are connected to each other in a communicative manner, and the control apparatus 200 and the notification apparatus 600 are connected to each other in a communicative manner. The interface 210 may be a communication device based on a specification such as Ethernet (registered trademark), for example. The interface 210 may include a relay device such as a switching hub.

The control unit 220 controls the operation of the ranging apparatuses 100T, 100L, and 100R, the notification apparatus 600, and the control apparatus 200. The signal processing unit 230 processes a signal acquired from the ranging apparatuses 100T, 100L, and 100R to acquire distance information on distances to the load G passing through the gate apparatus 103 and identification information of the load G. The functions of the control unit 220 and the signal processing unit 230 may be implemented when a processor such as a central processing unit (CPU) provided in the control apparatus 200 reads and executes a program from a storage device, for example. The storage unit 240 is a storage device that stores data acquired by the ranging apparatuses 100T, 100L, and 100R, a program and data used for the operation of the control apparatus 200, or the like. Accordingly, the control apparatus 200 has a function of controlling the ranging apparatuses 100T, 100L, and 100R and the notification apparatus 600 and a function of analyzing a signal acquired by the ranging apparatuses 100T, 100L, and 100R.

The communication unit 250 connects to the network NW in a wireless scheme such as mobile communication to transmit and receive data to and from the management server 30 or the like via the network NW. The control unit 220 can communicate with an external apparatus such as the management server 30 via the communication unit 250.

Furthermore, the signal processing unit 230 according to the present example embodiment has a volume calculation unit 232 that calculates the volume of the load G and an identification information acquisition unit 234 that acquires identification information on the load G.

As illustrated in FIG. 3, when the load G is loaded into the cargo space 42, the load G passes through the gate apparatus 103 installed to the loading port thereof. While the load G is passing through the gate apparatus 103, each of the ranging apparatuses 100T, 100L, and 100R of the gate apparatus 103 acquires distance distribution information indicating the distribution of distances to the load G as described below.

The ranging apparatuses 100T, 100L, and 100R emit light L to the load G passing through the gate apparatus 103 from respective entire emission surfaces. Each of the ranging apparatuses 100T, 100L, and 100R can emit the light L in a direction orthogonal to the emission surface thereof as the direction crossing the emission surface thereof, for example. Further, each of the ranging apparatuses 100T, 100L, and 100R can emit the light L including parallel light rays parallel to each other from the entire emission surface by performing a scan with the light L from the entire emission surface. The scanning scheme with the light L is not particularly limited, and the ranging apparatus 100T can perform a scan with the light L from the entire emission surface by using a raster scan that repeats a scan to move the light L in the lateral direction of the gate apparatus 103 and a scan to move the light L in the front-back direction of the gate apparatus 103, for example. Further, each of the ranging apparatuses 100L and 100R can perform a scan with the light L from the entire emission surface by using a raster scan that repeats a scan to move the light L in the vertical direction of the gate apparatus 103 and a scan to move the light L in the front-back direction of the gate apparatus 103.

Each of the ranging apparatuses 100T, 100L, and 100R detects reflected light of the light L, which has been emitted to the load G, from the load G. Accordingly, each of the ranging apparatuses 100T, 100L, and 100R acquires distance distribution information indicating a distribution of distances from each of the ranging apparatuses 100T, 100L, and 100R to the load G across the reference surface parallel to the emission surface. Since the distance distribution is acquired by a scan with the light L including parallel light rays parallel to each other as described above, a distance distribution can be accurately acquired. The ranging apparatuses 100T, 100L, and 100R can function as a dimension measurement unit that acquires two-dimensional distributions of distances to the load G from directions different from each other, respectively, and thereby measures three-dimensional dimensions of the load G when the load G is loaded into the cargo space 42 of the vehicle 40.

Note that the ranging apparatuses 100T, 100L, and 100R are not necessarily required to perform a scan with the light L including parallel light rays parallel to each other. The ranging apparatuses 100T, 100L, and 100R may be any ranging apparatus that emits the light L to the load G passing through the gate apparatus 103, such as a ranging apparatus that performs a rotation scan with respect to a predetermined rotation axis, for example.

Further, each of the ranging apparatuses 100T, 100L, and 100R is not necessarily required to be formed as a single ranging apparatus and may be formed of a plurality of ranging apparatuses provided for each of a plurality of divided regions, for example.

Further, any of the ranging apparatuses 100T, 100L, and 100R reads a code symbol displayed on the load G and outputs a reading signal while acquiring distance distribution information as described above. Any of the ranging apparatuses 100T, 100L, and 100R can read a code symbol in parallel to acquisition of distance distribution information. For example, in the case illustrated in FIG. 3, the ranging apparatus 100L reads a code symbol C displayed on the left side surface of the load G and outputs a reading signal. The ranging apparatus 100L reads the code symbol C while acquiring distance distribution information.

The volume calculation unit 232 calculates the volume of the load G passing through the gate apparatus 103 based on distance distribution information acquired by the ranging apparatuses 100T, 100L, and 100R, that is, the three-dimensional dimensions of the load G and size information related to the size of the gate apparatus 103. The volume calculation unit 232 can calculate information related to the height of the load G based on the distance distribution information acquired by the ranging apparatus 100T and the height of the ranging apparatus 100T, for example. Further, the volume calculation unit 232 can also calculate information related to the height of the load G based on the distance distribution information acquired by the ranging apparatuses 100L and 100R, for example. Further, the volume calculation unit 232 can calculates information related to the width of the load G based on the distance distribution information acquired by the ranging apparatuses 100L and 100R and the width between the ranging apparatus 100L and the ranging apparatus 100R, for example. Further, the volume calculation unit 232 can calculate information related to the length in the front-back direction of the load G based on the distance distribution information acquired by the ranging apparatuses 100L and 100R, for example. The volume calculation unit 232 can calculate the volume of the load G based on information related to the size of the load G calculated in such a way.

The identification information acquisition unit 234 acquires identification information that identifies the load G based on a reading signal output from any one of the ranging apparatuses 100T, 100L, and 100R which has read a code symbol displayed on the load G. The identification information on the load G acquired by the identification information acquisition unit 234 is used for inspection thereof.

In such a way, the gate system 2 according to the present example embodiment is configured. The gate system 2 according to the present example embodiment can acquire the volume of the load G passing through the gate apparatus 103 based on the distance distribution information or the like acquired by the ranging apparatuses 100T, 100L, and 100R, as described above. Furthermore, the gate system 2 according to the present example embodiment can acquire identification information on the load G passing through the gate apparatus 103 based on a reading signal output from any of the ranging apparatuses 100T, 100L, and 100R.

Note that the configuration of the gate system 2 described above is an example, and the gate system 2 may further include an apparatus that controls the gate apparatus 103 and the control apparatus 200 in an integral manner. Further, the gate system 2 may be an integrated type apparatus in which the function of the control apparatus 200 is embedded in the gate apparatus 103.

The management server 30 is installed in a base facility such as a distribution center of a freight company or the like that manages the vehicles 40, for example. The management server 30 is configured to be able to manage the loads G to be loaded into one or a plurality of vehicles 40. The management server 30 has a control unit 32, a storage unit 34, and a communication unit 36, as illustrated in FIG. 2.

The control unit 32 controls the operation of the management server 30. The function of the control unit 32 may be implemented when a processor such as a CPU provided in the management server 30 reads and executes a program from a storage device, for example. The storage unit 34 is a storage device that stores a program and data used for the operation of the management server 30 or the like. Further, the storage unit 34 stores a management database (DB) 34a that manages the vehicle 40 and the loads G loaded in the cargo space 42 of the vehicle 40. The control unit 32 can perform inspection by matching identification information on the load G acquired by the gate system 2 and transmitted to the management server 30. Further, the control unit 32 can register, in the management DB 34a, and manage the volume of the load G acquired by the gate system 2 and transmitted to the management server 30 in association with identification information on the load G.

The communication unit 36 connects to the network NW in a wired scheme or a wireless scheme to transmit and receive data to and from the control apparatus 200 or the like of the gate system 2 via the network NW. The control unit 32 can communicate with an external apparatus such as the control apparatus 200 or the like of the gate system 2 via the communication unit 36.

In such a way, the management server 30 according to the present example embodiment is configured.

The gate system 2 according to the present example embodiment acquires identification information on the load G used for inspection when the load G is loaded into the cargo space 42 of the vehicle 40. Thus, the gate system 2 according to the present example embodiment does not require any additional work such as unloading for inspection when the load G is loaded into the cargo space 42 of the vehicle 40. Furthermore, the gate system 2 according to the present example embodiment also measures and acquires distance distribution information, that is, the three-dimensional dimensions of the load G by using the ranging apparatuses 100T, 100L, and 100R of the gate apparatus 103 when the load G is loaded into the cargo space 42 of the vehicle 40. The gate system 2 can acquire the volume of the load G based on the acquired three-dimensional dimensions of the load G. Therefore, according to the present example embodiment, high working efficiency can be realized in loading of the load G into the vehicle 40. Further, the volume of the load G acquired in loading into the cargo space 42 can be used for management of a loading rate of the load G in the cargo space 42, and therefore efficient transportation of the load G can be realized.

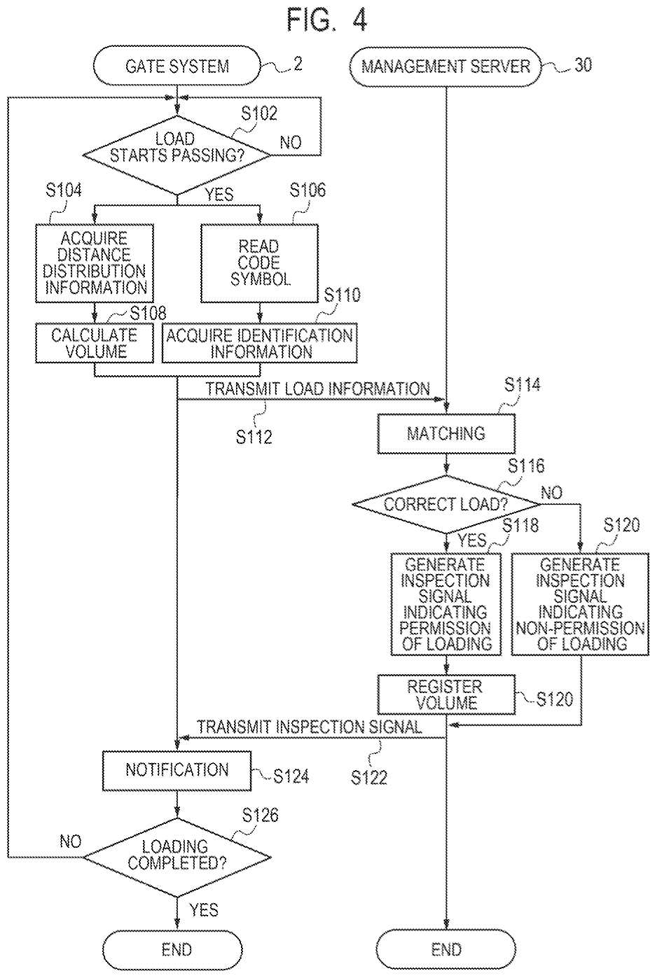

Next, the operation of the gate system 2 and the management server 30 in the loading management system 1 according to the present example embodiment will be further described with reference to FIG. 4. FIG. 4 is a flowchart illustrating the operations of the gate system 2 and the management server 30 in the loading management system 1 according to the present example embodiment. With these operations, the information processing method according to the present example embodiment is performed.

For example, in a vehicle berth B such as a distribution center, the loads G are loaded into the cargo space 42 by a driver of the vehicle 40, a loading worker, or the like at the vehicle 40 in which the gate apparatus 103 is installed to the loading port of the cargo space 42. The loading of the loads G into the cargo space 42 may be performed by manual work or may be performed by using equipment such as a forklift, a lifter, a crane, a winch, or the like, for example.

The control unit 220 of the gate system 2 determines whether or not the load G starts passing through the gate apparatus 103 (step S102) and stands by until the load G starts passing (step S102, NO). The control unit 220 can determine whether or not the load G starts passing through the gate apparatus 103 in accordance with distance distribution information acquired by at least any one of the ranging apparatuses 100T, 100L, and 100R, for example. Further, the control unit 220 can also determine whether or not the load G starts passing through the gate apparatus 103 based on an output signal of a passage detection sensor provided in the gate apparatus 103 separately from the ranging apparatuses 100T, 100L, and 100R, for example. Further, the control unit 220 can also determine whether or not the load G starts passing through the gate apparatus 103 based on switch input made by a driver, a loading worker, or the like, for example. The control unit 220 can use various methods other than the above to determine whether or not the load G starts passing through the gate apparatus 103.

If the control unit determines that the load G starts passing through the gate apparatus 103 (step S102, YES), the control unit 220 controls the ranging apparatuses 100T, 100L, and 100R to cause the ranging apparatuses 100T, 100L, and 100R to acquire distance distribution information (step S104). Accordingly, the control unit 220 causes the ranging apparatuses 100T, 100L, and 100R to measure the three-dimensional dimensions of the load G.

Further, the control unit 220 controls any one of the ranging apparatuses 100T, 100L, and 100R to cause any one of the ranging apparatuses 100T, 100L, and 100R to read a code symbol displayed on the load G (step S106). Since the acquisition of the distance distribution information and the reading of the code symbol can be performed in parallel, high working efficiency can be realized.

The load G passes through the gate apparatus 103 and is loaded into the cargo space 42 while the three-dimensional dimensions and identification information being acquired by the ranging apparatuses 100T, 100L, and 100R.

Next, the volume calculation unit 232 calculates the volume of the load G passing through the gate apparatus 103 based on the distance distribution information acquired by the ranging apparatuses 100T, 100L, and 100R and size information related to the size of the gate apparatus 103 (step S108). That is, the volume calculation unit 232 calculates the volume of the load G passing through the gate apparatus 103 based on the three-dimensional dimensions of the load G acquired by the ranging apparatuses 100T, 100L, and 100R.

Further, the identification information acquisition unit 234 acquires identification information on the load G based on a reading signal output from any one of the ranging apparatuses 100T, 100L, and 100R which reads the code symbol of the load G (step S110).

Next, the control unit 220 transmits load information that is information related to the load G that has passed through the gate apparatus 103 and has been loaded in the cargo space 42 to the management server 30 via the network NW (step S112). The load information includes at least the identification information on the load G acquired by the identification information acquisition unit 234 and the volume calculated by the volume calculation unit 232. The load information can also include another information related to time of completion of loading, scheduled time of departure of the vehicle 40, or the like in addition to the above.

In response to receiving the load information from the control apparatus 200 of the gate system 2, the control unit 32 of the management server 30 matches the identification information included in the received load information with the identification information on the load G registered in the management DB 34a (step S114). In the management DB 34a, identification information on the load G to be loaded into the vehicle 40 of interest, sender information, destination information, transportation date and time, or other information are registered.

The control unit 32 determines based on a result of the matching of the identification information whether or not the load G of interest is a correct load to be loaded into the cargo space 42 of the vehicle 40 of interest (step S116). If the identification information included in the load information and the identification information in the management DB 34a are matched, the control unit 32 determines that the load G of interest is a correct load to be loaded into the cargo space 42 of the vehicle 40 of interest. If not matched, the control unit 32 determines that the load G of interest is not a correct load to be loaded, that is, a wrong load not to be loaded into the cargo space 42 of the vehicle 40 of interest.

If the control unit 32 determines that the load G is a correct load (step S116, YES), the control unit 32 generates an inspection signal indicating that the loading of the load G into the vehicle 40 is permitted (step S118). Subsequently, the control unit 32 registers the volume, which is included in the load information on the load G permitted to be loaded, in the management DB 34a in association with the identification information thereon (step S120). By managing the volume of the load G loaded in the cargo space 42 of the vehicle 40, it is possible to recognize a loading rate of the loads G in the cargo space 42, and it is therefore possible to realize efficient transportation of the loads G at a high loading rate.

On the other hand, if the control unit 32 determines that the load G is a wrong load (step S116, NO), the control unit 32 generates an inspection signal indicating that the loading of the load G into the vehicle 40 is not permitted (step S120).

Next, the control unit 32 transmits an inspection signal generated as described above indicating the permission or non-permission of the loading of the load G to the control apparatus 200 of the gate system 2 via the network NW (step S122).

In response to receiving the inspection signal from the management server 30, the control unit 220 of the gate system 2 controls the notification apparatus 600 to cause the notification apparatus 600 to notify the driver, the loading worker, or the like of permission or non-permission of the loading of the load G in accordance with the inspection signal (step S124). If notified of non-permission of the loading, the driver, the loading worker, or the like are able to stop the loading of the load G of interest into the cargo space 42 and thus prevent erroneous loading of the load G.

After the load G is loaded into the cargo space 42 in such a way, the control unit 220 determines whether or not all the loads G to be loaded into the cargo space 42 have been loaded and the loading of the loads G is completed for the vehicle 40 (step S126). The control unit 220 can determine whether or not the loading of the loads G is completed based on a completion signal indicating completion of loading received via the network NW from the management server 30 that manages the loads G, for example. Further, the control unit 220 can determine whether or not the loading of the loads G is completed based on input indicating the completion of loading made by a driver, a loading worker, or the like, for example.

If the control unit 220 determines that the loading of the loads G is not completed (step S126, NO), the control unit 220 proceeds with the process to step S102 and waits for loading of the next load G. On the other hand, if the control unit 220 determines that the loading of the loads G is completed (step S126, YES), the control unit 220 determines that the loading of the loads G into the vehicle 40 of interest is completed and can stop the operation of the gate apparatus 103 or cause the gate apparatus 103 to enter a standby state, for example.

As described above, according to the present example embodiment, three-dimensional dimensions of the load G are measured and acquired by the ranging apparatuses 100T, 100L, and 100R when the load G is loaded into the cargo space 42 of the vehicle 40, and the volume of the load G is acquired based on the three-dimensional dimensions. Furthermore, according to the present example embodiment, a signal used for acquiring identification information on the load G is read from the load G in measurement of the three-dimensional dimensions of the load G. Therefore, according to the present example embodiment, it is possible to realize high working efficiency in loading of the load G into the vehicle 40.

### Second Example Embodiment

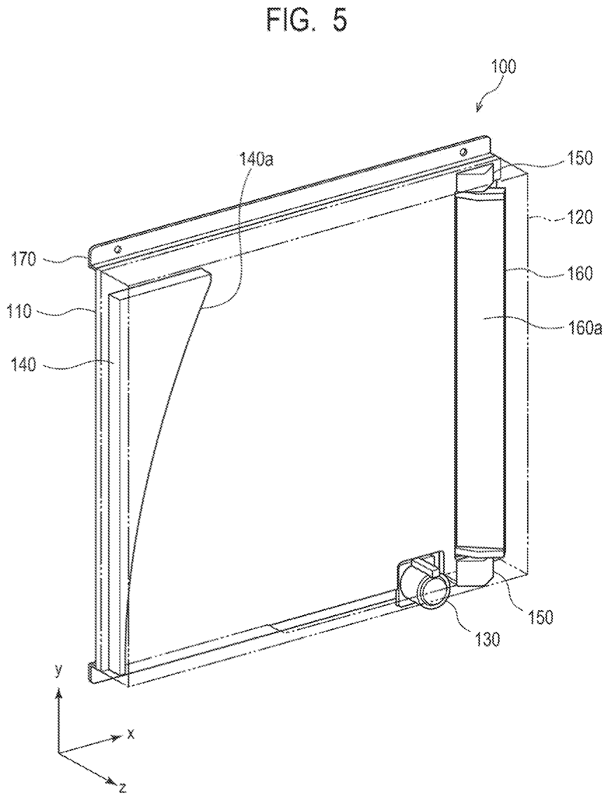

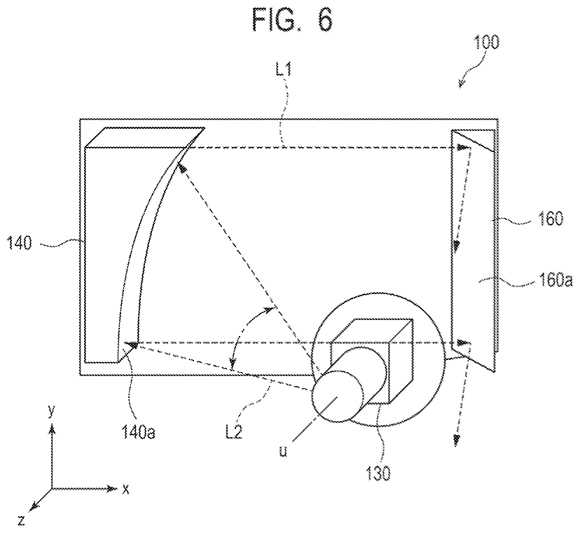

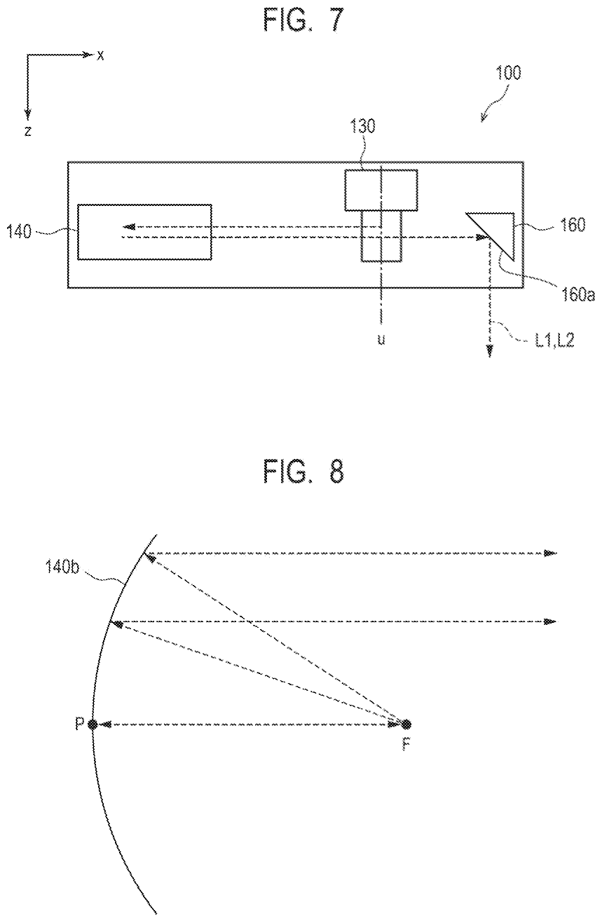

A ranging apparatus according to a second example embodiment of the present invention will be described with reference to FIG. 5 to FIG. 7. FIG. 5 is a schematic perspective view illustrating the structure of a ranging apparatus 100 according to the second example embodiment. FIG. 6 is a schematic diagram illustrating the structure of the ranging apparatus 100 when viewed from the front. FIG. 7 is a schematic diagram illustrating the structure of the ranging apparatus 100 when viewed from the top. The structure of the ranging apparatus 100 will be described with cross-reference to these drawings. Note that an x-axis, a y-axis, and a z-axis illustrated in each drawing are provided for assistance of description and are not intended to limit the installation direction of the ranging apparatus 100. In the present example embodiment, first, the ranging apparatus 100 configured to enable a parallel scan in which a light path moves in the y-axis direction in parallel will be described as a basic configuration of the ranging apparatuses 100T, 100L, and 100R according to the first example embodiment. Note that, for example, together with a configuration that enables a parallel scan in which a light path moves in the x-axis direction in parallel, such a combination can be employed as the ranging apparatuses 100T, 100L, and 100R according to the first example embodiment, as described later.

As illustrated in FIG. 5, the ranging apparatus 100 has a base 110, a cover 120, a sensor unit 130, a parabolic reflecting mirror 140, a position adjustment mechanism 150, a plane reflecting mirror 160, and an attachment part 170.

The base 110 is a rectangular plate-like member and functions as a part of a casing of the ranging apparatus 100. Further, the base 110 has a function of fixing the sensor unit 130, the parabolic reflecting mirror 140, the plane reflecting mirror 160, and the like to predetermined positions.

The cover 120 is a lid covering the base 110 and functions as a part of a casing of the ranging apparatus 100. The parabolic reflecting mirror 140, the position adjustment mechanism 150, and the plane reflecting mirror 160 are arranged in the internal space of the casing surrounded by the base 110 and the cover 120.

The sensor unit 130 is a two-dimensional LiDAR device. As illustrated in FIG. 6, the sensor unit 130 can perform rotation scan about the rotation axis u. The rotation axis u may also be referred to as a first rotation axis. The sensor unit 130 has a laser device that emits laser light and a photoelectric conversion element that receives reflected light reflected by a target object and converts the reflected light into an electrical signal. The sensor unit 130 is arranged in a notch formed in the lower part of the base 110 and the cover 120, as illustrated in FIG. 5. The light emitted from the sensor unit 130 is caused to enter a reflective surface 140a of the parabolic reflecting mirror 140.

As an example of a distance detection scheme performed by the sensor unit 130, a Time Of Flight (TOF) scheme may be used. The TOF scheme is a method for measuring a distance by measuring time from emission of light to reception of reflected light.

Note that the laser light emitted from the sensor unit 130 may be visible light or may be invisible light such as an infrared ray. Such laser light may be an infrared ray having a wavelength of 905 nm, for example.

The parabolic reflecting mirror 140 is a reflecting mirror having a reflective surface 140a. The parabolic reflecting mirror 140 may also be referred to as a first reflecting mirror. The reflective surface 140a forms a parabola whose focal point is a point on the rotation axis u on a cross section perpendicular to the rotation axis u (the xy plane in FIG. 6). In other words, the sensor unit 130 is arranged near the focal point of the parabola formed by the reflective surface 140a, and the rotation axis u is arranged at a position passing through the focal point of the parabola formed by the reflective surface 140a. The rotation axis u is parallel to the z-axis in FIG. 6. The equation of the parabola is expressed by Equation (1) below, where the coordinates of the parabola vertex are denoted as P(0, 0), and the coordinates of the focal point are denoted as (a, 0).

[Math. 1]

y²=4ax (1)

According to the mathematical nature of a parabola, when light emitted from the sensor unit 130 is reflected by a reflective surface 140a, the emission direction of reflected light is parallel to the parabola axis regardless of the angle of the emission light. That is, as illustrated in FIG. 6, for a light path L1 and a light path L2 having different emission angles from the sensor unit 130, rays of reflected light reflected by the reflective surface 140a are parallel to each other. In such a way, with the sensor unit 130 being arranged at the focal point of the reflective surface 140a, this enables a parallel scan in which a light path moves in the y-axis direction in parallel in response to rotation of emission light.

Note that the material of the parabolic reflecting mirror 140 may be an aluminum alloy whose primary component is aluminum, for example. In such a case, the reflective surface 140a may be formed by smoothing the surface of an aluminum alloy by mirror polishing or plating, for example. Note that other parabolic reflecting mirrors described later may be formed of the same material and by the same process.

The plane reflecting mirror 160 is a reflecting mirror having a reflective surface 160a at least partially forming a plane. The plane reflecting mirror 160 may also be referred to as a second reflecting mirror. The reflective surface 160a is provided on light paths of reflected light from the reflective surface 140a. As illustrated in FIG. 6 and FIG. 7, the plane reflecting mirror 160 changes the direction of light reflected by the reflective surface 140a to a different direction from the xy plane. More specifically, reflected light from the plane reflecting mirror 160 travels in substantially the z-axis direction, that is, in a direction substantially parallel to the rotation axis u. The reflected light from the plane reflecting mirror 160 is emitted out of the ranging apparatus. Accordingly, the direction of the emission light from the ranging apparatus 100 is not limited to a direction parallel to the axis of the reflective surface 140a.

Note that the material of the plane reflecting mirror 160 may be an aluminum alloy whose primary component is aluminum, for example, in the same manner as the parabolic reflecting mirror 140. In such a case, the reflective surface 160a of the plane reflecting mirror 160 may be formed by smoothing in the same manner as for the reflective surface 140a or may be formed by attaching an aluminum alloy plate having specular gloss to a base member. Note that other plane reflecting mirrors described later may be formed of the same material and by the same process.

Herein, the cover 120 is configured to neither absorb nor reflect a reflected light from the plane reflecting mirror 160. Specifically, for example, a region of the cover 120 through which reflected light from the plane reflecting mirror 160 passes may be formed of a transparent material. An example of a transparent material may be an acrylic resin. Alternatively, a window may be provided so that a region of the cover 120 through which reflected light from the plane reflecting mirror 160 passes is a hollow.

The attachment part 170 is a portion by which the ranging apparatus 100 is attached and fixed to the casing or the like of the gate apparatus 103. By being fixed by the attachment part 170, the ranging apparatus 100 can be attached in any orientations. The position adjustment mechanism 150 is a mechanism used for finely adjusting the position of the plane reflecting mirror 160 when attaching the ranging apparatus 100 to the casing or the like of the gate apparatus 103. Note that a drive mechanism that moves the plane reflecting mirror 160 may be provided instead of the position adjustment mechanism 150.

The light paths L1 and L2 illustrated in FIG. 6 and FIG. 7 are illustration for light paths when light is emitted out of the sensor unit 130. In contrast, light is reflected by a target object and enters the ranging apparatus 100 passes through substantially the same path as the light paths L1 and L2 in the opposite direction and is received by the sensor unit 130.

The ranging apparatus 100 of the present example embodiment is structured thick in the axial direction of the parabolic reflecting mirror 140 due to the thickness of the parabolic reflecting mirror 140, constraints of the arrangement position of the sensor unit 130, or the like. In contrast, the ranging apparatus 100 of the present example embodiment has the plane reflecting mirror 160 that reflects light reflected from the parabolic reflecting mirror 140. The plane reflecting mirror 160 can change the direction of the emission light from the ranging apparatus 100 to a different direction from the axial direction of the parabola formed by the parabolic reflecting mirror. Thus, since the ranging apparatus 100 of the present example embodiment can direct the light emission direction to a different direction from the axial direction of the parabolic reflecting mirror 140, the thickness in the light emission direction can be reduced. Accordingly, the ranging apparatus 100 of the present example embodiment can form the gate apparatus 103 that can be installed in a space-saving manner. Therefore, according to the present example embodiment, the ranging apparatus 100 having improved flexibility for an installation place is provided.

Further, in the ranging apparatus 100 according to the present example embodiment, the reflective surface 140a of the parabolic reflecting mirror 140 is provided so as to be absent at the parabola vertex. The reason for such a configuration will be described with reference to FIG. 8 to FIG. 10.

FIG. 8 is a diagram of light paths when a reflective surface 140b is provided through the parabola vertex P. For simplified illustration, the sensor unit 130 is indicated in a simplified manner as a point light source arranged at the focal point F of the reflective surface 140b. When light emitted from the focal point F is not parallel to the parabola axis (when the light does not travel in a direction toward the vertex P), the reflected light does not pass through the focal point F. However, when light emitted from the focal point F is parallel to the parabola axis (the light travels in a direction toward the vertex P) and is reflected at the vertex P, the reflected light passes through the focal point F. Therefore, light emitted from the sensor unit 130 re-enters the sensor unit 130. In such a case, noise may occur on a signal measured when the sensor unit 130 receives reflected light different from reflected light from a target object. In such a way, if the reflective surface 140b is provided thorough the parabola vertex P, detection accuracy may decrease, and sufficient detection accuracy may be unable to be ensured.

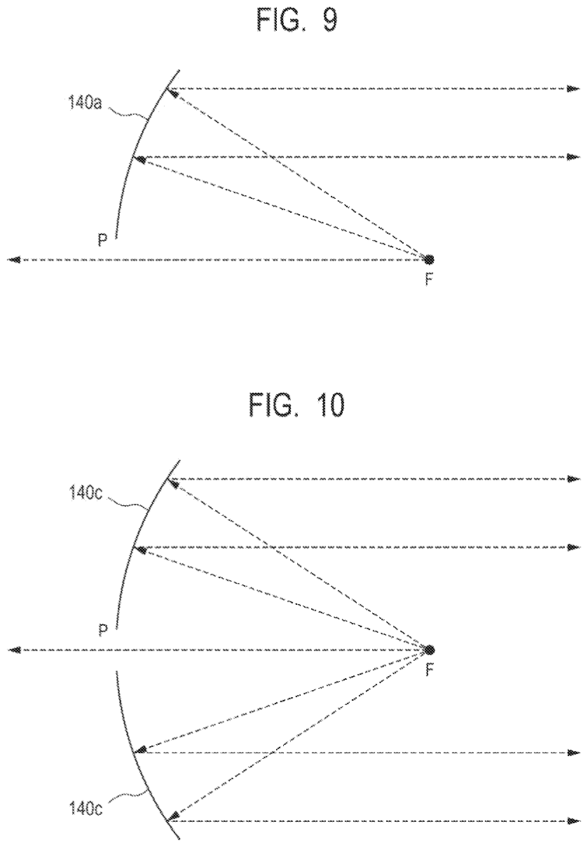

In contrast, in the ranging apparatus 100 of the present example embodiment, as illustrated in FIG. 9, the reflective surface 140a is provided so as to be absent at the parabola vertex P. Thus, even when light emitted from the focal point F is parallel to the parabola axis, the light is not reflected. Therefore, since reflected light does not re-enter the sensor unit 130, it is possible to suppress a reduction in detection accuracy. As described above, according to the present example embodiment, because the reflective surface 140a of the parabolic reflecting mirror 140 is provided so as to be absent at the parabola vertex, the ranging apparatus 100 having improved detection accuracy is provided.

Note that, although the reflective surface 140a is arranged on one side of the parabola axis in FIG. 9, a configuration in which reflective surfaces 140c are arranged on both sides so as not to include the parabola vertex P may be employed as indicated in a modified example illustrated in FIG. 10. A specific configuration example corresponding to this modified example will be described later.

### Third Example Embodiment

Next, as a third example embodiment of the present invention, a configuration example of a ranging apparatus that can move a plane reflecting mirror in parallel will be described. Description of components common to those in the example embodiments described above will be omitted or simplified. In the third to eighth example embodiments below, ranging apparatuses 101, 102, 300, 301, 400, and the like will be described as a specific example of a ranging apparatus that can be employed as the configuration of the ranging apparatuses 100T, 100L, and 100R of the first example embodiment.

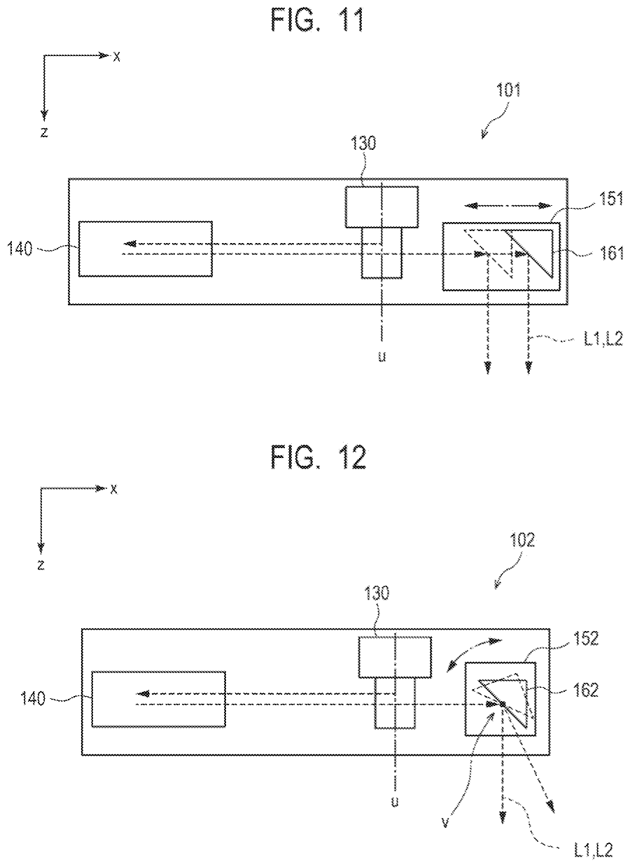

FIG. 11 is a schematic diagram illustrating the structure of the ranging apparatus 101 of the present example embodiment when viewed from the top. The ranging apparatus 101 of the present example embodiment has a drive mechanism 151 instead of the position adjustment mechanism 150 and has a plane reflecting mirror 161 instead of the plane reflecting mirror 160. The drive mechanism 151 drives the plane reflecting mirror 161 in parallel to the axial direction of the parabolic reflecting mirror 140 (the x-axis direction in FIG. 11). The drive mechanism 151 includes a drive device such as a motor. Further, the drive mechanism 151 includes a device that acquires position information on the plane reflecting mirror 161, such as an encoder. These devices are controlled by the control apparatus 200. Further, the position information on the plane reflecting mirror 161 acquired by the drive mechanism 151 is supplied to the control apparatus 200.

When the plane reflecting mirror 161 is driven by the drive mechanism 151 and moves in the x-axis direction in parallel, reflected light from the plane reflecting mirror 161 similarly moves in the x-axis direction in parallel. This enables the ranging apparatus 101 of the present example embodiment to perform a scan to move reflected light from the plane reflecting mirror 161 in the x-axis direction in parallel. Further, the ranging apparatus 101 of the present example embodiment can also perform a scan to move reflected light from the plane reflecting mirror 161 in the y-axis direction in parallel in the same manner as in the second example embodiment. Therefore, the ranging apparatus 101 of the present example embodiment functions as a three-dimensional sensor device that can acquire three-dimensional position information by combining two-dimensional scan in the x-axis direction and the y-axis direction and distance measurement in the z-axis direction in addition that the same advantageous effects as in the second example embodiment can be obtained.

### Fourth Example Embodiment

Next, as a fourth example embodiment of the present invention, a configuration example of a ranging apparatus that can rotate and move a plane reflecting mirror will be described. Description of components common to those in the second example embodiment will be omitted or simplified.

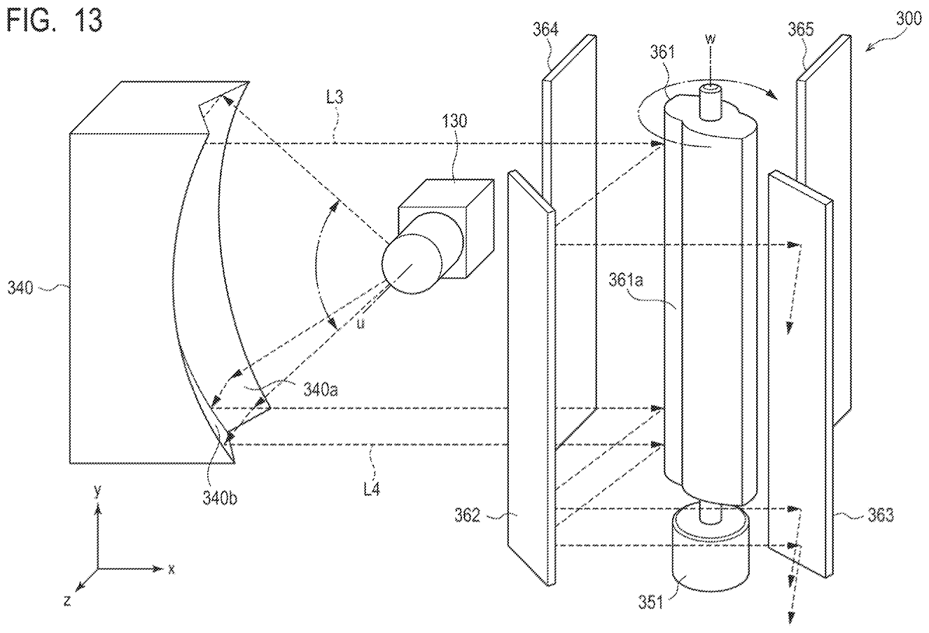

FIG. 12 is a schematic diagram illustrating the structure of the ranging apparatus 102 of the present example embodiment when viewed from the top. The ranging apparatus 102 of the present example embodiment has a drive mechanism 152 instead of the position adjustment mechanism 150 and has a plane reflecting mirror 162 instead of the plane reflecting mirror 160. The drive mechanism 152 drives the plane reflecting mirror 162 so as to rotate the plane reflecting mirror 162 about the rotation axis v parallel to the y-axis. The position of the rotation axis v can be any position as long as the direction of reflected light from the plane reflecting mirror 162 changes in accordance with the rotation and may be, for example, on a path through which reflected light from the parabolic reflecting mirror 140 passes. The drive mechanism 152 includes a drive device such as a motor. Further, the drive mechanism 152 includes a device that acquires angle information on the plane reflecting mirror 162 such as an encoder. These devices are controlled by the control apparatus 200. Further, angle information on the plane reflecting mirror 162 acquired by the drive mechanism 152 is supplied to the control apparatus 200.

When the plane reflecting mirror 162 is driven by the drive mechanism 152 and rotated and moved, the direction of reflected light from the plane reflecting mirror 162 is also rotated. This enables the ranging apparatus 102 of the present example embodiment to perform a scan to rotate and move the direction of reflected light from the plane reflecting mirror 162. Further, the ranging apparatus 102 of the present example embodiment can also perform a scan to move reflected light from the plane reflecting mirror 162 in the y-axis direction in parallel in the same manner as in the second example embodiment. Therefore, the ranging apparatus 102 of the present example embodiment functions as a three-dimensional sensor device that can acquire three-dimensional position information by combining rotation movement on the rotation axis v, parallel movement in the y-axis direction, and distance measurement, in addition that the same advantageous effects as in the second example embodiment can be obtained.

### Fifth Example Embodiment

Next, as a fifth example embodiment of the present invention, a configuration example of a ranging apparatus further having a logarithm spiral reflecting mirror will be described. Description of components common to those in the example embodiments described above will be omitted or simplified.

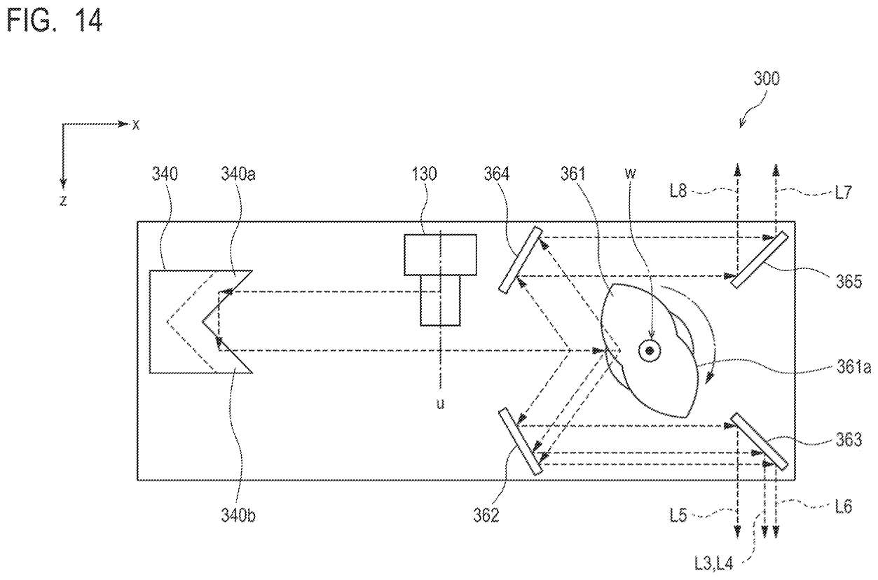

FIG. 13 is a schematic perspective view illustrating the structure of the ranging apparatus 300 according to the fifth example embodiment. FIG. 14 is a schematic diagram illustrating the structure of the ranging apparatus 300 when viewed from the top. The structure of the ranging apparatus 300 will be described with cross-reference to FIG. 13 and FIG. 14. Note that FIG. 13 and FIG. 14 may omit some depiction of components not required for description of light paths, such as the base 110, the cover 120, the attachment part 170, or the like.

The ranging apparatus 300 has the sensor unit 130, a parabolic reflecting mirror 340, a drive mechanism 351, a logarithm spiral reflecting mirror 361, and plane reflecting mirrors 362, 363, 364, and 365. The parabolic reflecting mirror 340 has reflective surfaces 340a and 340b. Each of the reflective surfaces 340a and 340b forms a parabola whose focal point is a point on the rotation axis u on a cross section perpendicular to the rotation axis u (the xy plane in FIG. 13). The reflective surface 340a and the reflective surface 340b are in a positional relationship of being perpendicular to each other on the xz plane, as illustrated in FIG. 14. Note that the parabolic reflecting mirror 340, the plane reflecting mirror 363, the logarithm spiral reflecting mirror 361, and the plane reflecting mirror 365 may also be referred to as a first reflecting mirror, a second reflecting mirror, a third reflecting mirror, and a fourth reflecting mirror, respectively.

The light emitted from the sensor unit 130 in the negative x-axis direction is reflected at the reflective surface 340a in the z-axis direction and then reflected at the reflective surface 340b in the positive x-axis direction toward the logarithm spiral reflecting mirror 361. By shifting the light path in the z direction with two times of reflection at the reflective surfaces 340a and 340b, it is possible that reflected light at the parabolic reflecting mirror 340 is not blocked by the sensor unit 130. Further, since reflected light does not re-enter the sensor unit 130, detection accuracy can be improved for the same reason as described with reference to FIG. 8 to FIG. 10.

The logarithm spiral reflecting mirror 361 has a columnar shape and has a reflective surface 361a forming a logarithm spiral on the side surface thereof. Light emitted from the sensor unit 130 is reflected by the reflective surface 361a. The logarithm spiral reflecting mirror 361 can be rotated about the rotation axis w by the drive mechanism 351. At this time, light reflected at the reflective surface 361a moves in parallel in accordance with the angle of the logarithm spiral reflecting mirror 361. Note that the rotation axis w may also referred to as a second rotation axis.

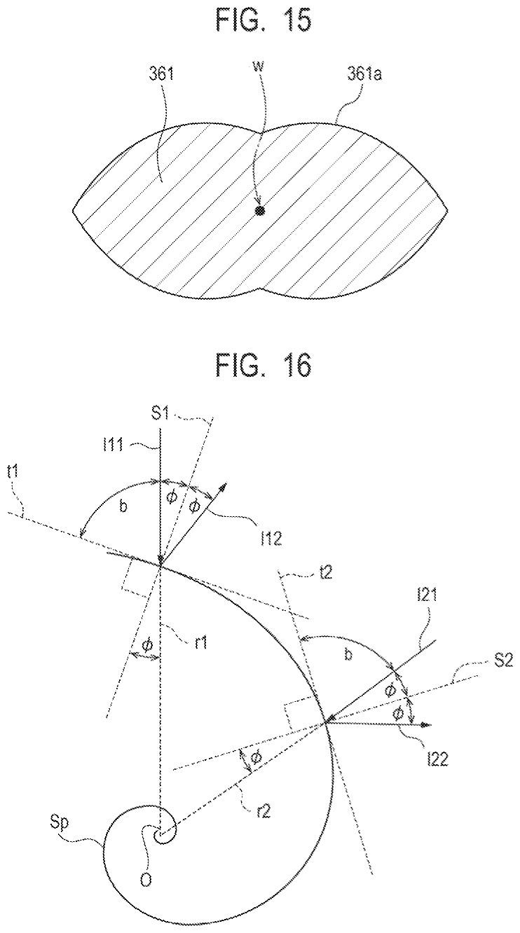

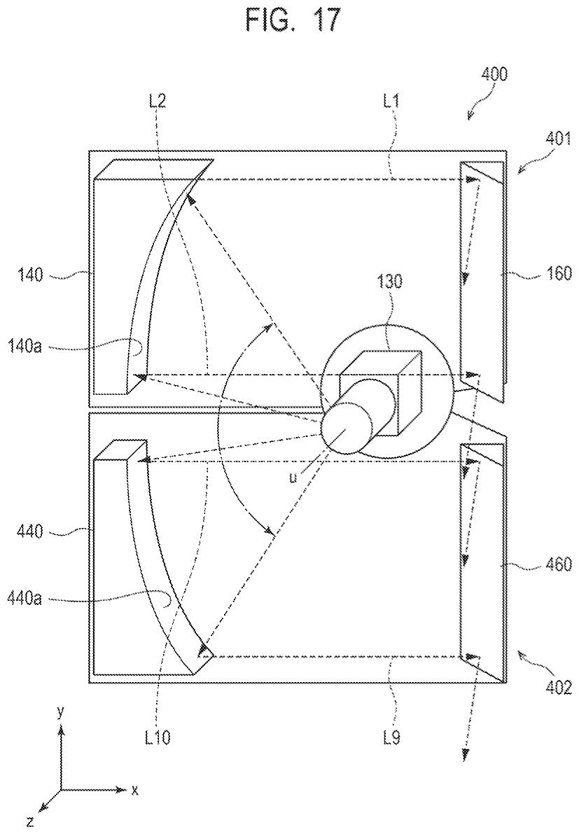

The structure of the logarithm spiral reflecting mirror 361 will be described in more detail with reference to FIG. 15 and FIG. 16. FIG. 15 is a sectional view of the logarithm spiral reflecting mirror 361 according to the present example embodiment taken along a plane perpendicular to the rotation axis w. The reflective surface 361a that is the side surface of the logarithm spiral reflecting mirror 361 forms a closed curve in which four logarithm spirals are continuously connected on a cross section perpendicular to the rotation axis w. With such a closed curve having the continuously connected logarithm spirals, this realizes a configuration in which the whole reflective surface 361a, which light emitted from the sensor unit 130 may enter, forms a logarithm spiral on the cross section perpendicular to the rotation axis w. Accordingly, reflected light can be utilized for a scan even when light enters any surface of the logarithm spiral reflecting mirror 361. Note that a logarithm spiral may also be referred to as an equiangular spiral or a Bernoulli's spiral.

FIG. 16 is a diagram illustrating reflection of light at a reflective surface forming a logarithm spiral. A logarithm spiral Sp is expressed by a polar equation of Equation (2) below, where a dynamic radius of the polar coordinate is denoted as r, a deflection angle in the polar coordinate is denoted as θ, the value of r when θ is zero is “a”, and an angle of a tangential line of the logarithm spiral relative to a line passing through the center of the logarithm spiral is b.

[Math. 2]

r=a·exp(θ·cot b) (2)

The relationship between incident light I11 and 121 traveling to the origin O of the polar equation of Equation (2) from outside of the logarithm spiral Sp and corresponding reflected light 112 and 122 is now considered. The tangential lines at points where the incident light I11 and the incident light 121 are reflected on the logarithm spiral Sp are denoted as t1 and t2, and the normal lines thereof are denoted as S1 and S2, respectively. The incident light I11 is reflected at the point on a dynamic radius r1 of the logarithm spiral Sp, and the incident light 121 is reflected at the point on a dynamic radius r2 of the logarithm spiral Sp (note that r1≠r2). In this case, due to the nature of the logarithm spiral Sp, both of the angle between the incident light I11 and the tangential line t1 and the angle between the incident light 121 and the tangential line t2 are b. Therefore, the incident angle φ between the incident light I11 and the normal line S1 and the incident angle φ between the incident light 121 and the normal line S2 are the same. Further, the reflection angle φ between the reflected light 112 and the normal line S1 and the reflection angle φ between the reflected light 122 and the normal line S2 are the same. When φ and b are angles expressed by the circular measure, the relationship between φ and b is expressed as Equation (3) below.

$$\begin{matrix}[ Math . 3 ] & \\ ϕ = \frac{π}{2} - b & ( 3 )\end{matrix}$$

It is found from the above that the incident light I11 traveling from outside of the logarithm spiral Sp to the origin O is reflected at the same reflection angle φ when reflected at any point on the logarithm spiral Sp. Thus, when the logarithm spiral Sp is rotated about the origin O, although the point at which the incident light I11 to the logarithm spiral Sp is reflected changes, the direction in which the reflected light 112 is reflected does not change, and thus the reflected light 112 moves in parallel.

To utilize such a nature, the logarithm spiral reflecting mirror 361 of the present example embodiment is formed such that at least a part of the reflective surface is a logarithm spiral whose rotation axis w corresponds to the origin O on the cross section perpendicular to the rotation axis w. Accordingly, by rotating the logarithm spiral reflecting mirror 361 around the rotation axis w, it is possible to perform a scan such that light reflected by the reflective surface 361a moves in parallel.

Turning back to FIG. 14, a parallel scan with reflected light by using the logarithm spiral reflecting mirror 361 will be described. Light reflected by the logarithm spiral reflecting mirror 361 enters and is reflected by either the plane reflecting mirror 362 or the plane reflecting mirror 364 in accordance with the angle of the logarithm spiral reflecting mirror 361. The light reflected by the plane reflecting mirror 362 is reflected by the plane reflecting mirror 363 and emitted out of the ranging apparatus 300. At this time, the emission direction is the positive z-axis direction. The light reflected by the plane reflecting mirror 364 is reflected by the plane reflecting mirror 365 and emitted out of the ranging apparatus 300. At this time, the emission direction is the negative z-axis direction.

When the logarithm spiral reflecting mirror 361 is rotated clockwise as illustrated in FIG. 14, the light emitted out of the ranging apparatus 300 moves in parallel from the light path L5 to the light path L6. When the logarithm spiral reflecting mirror 361 is further rotated with the emission light being on the light path L6, the emission light changes discontinuously from the light path L6 to the light path L7. The emission light then moves in parallel from the light path L7 to the light path L8 and discontinuously changes from the light path L8 to the light path L5. In such a way, the ranging apparatus 300 of the present example embodiment can alternatingly scan different directions of the positive direction and the negative direction of the z-axis. Note that a scan with light directed to either one of the different directions of the positive direction and the negative direction of the z-axis can be used for the ranging apparatuses 100T, 100L, and 100R in the gate system 2.

Accordingly, the ranging apparatus 300 of the present example embodiment can perform a scan to move emission light in the x-axis direction in parallel. Further, the ranging apparatus 300 of the present example embodiment can also perform a scan to move the emission light in the y-axis direction in parallel in the same manner as in the second example embodiment. Therefore, the ranging apparatus 300 of the present example embodiment functions as a three-dimensional sensor device that can acquire three-dimensional position information by combining two-dimensional scan in the x-axis direction and the y-axis direction and distance measurement in the z-axis direction in addition that the same advantageous effects as in the second example embodiment can be obtained. Furthermore, since the ranging apparatus 300 of the present example embodiment can alternatingly scan the positive direction and the negative direction of the z-axis, it is possible to perform ranging of two directions different from each other by using a single ranging apparatus 300.

### Sixth Example Embodiment

Next, as a sixth example embodiment of the present invention, a configuration example of a ranging apparatus having two optical systems will be described. Description of components common to those in the example embodiments described above will be omitted or simplified.

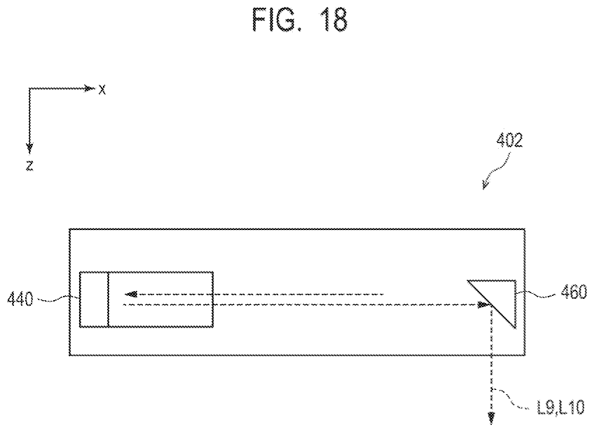

FIG. 17 is a schematic diagram illustrating the structure of the ranging apparatus 400 according to the sixth example embodiment when viewed from the front. FIG. 18 is a schematic diagram illustrating the structure of the ranging apparatus 400 when viewed from the top. The structure of the ranging apparatus 400 will be described with cross-reference to these drawings.

The ranging apparatus 400 has a first optical system 401 and a second optical system 402. The first optical system 401 has the sensor unit 130, the parabolic reflecting mirror 140, and the plane reflecting mirror 160. Since the first optical system 401 is the same as that of the ranging apparatus 100 of the second example embodiment, the description thereof will be omitted. Note that the top view of the first optical system 401 is the same as FIG. 7.

The second optical system 402 has a parabolic reflecting mirror 440 and a plane reflecting mirror 460. The parabolic reflecting mirror 440 has a reflective surface 440a. The reflective surface 440a forms a parabola whose focal point is a point on the rotation axis u on the cross section perpendicular to the rotation axis u (the xy plane in FIG. 17). The parabolic reflecting mirror 440 has line-symmetrical structure with respect to the parabolic reflecting mirror 140. Further, the plane reflecting mirror 460 has line-symmetrical structure with respect to the plane reflecting mirror 160. The parabolic reflecting mirror 140 and the parabolic reflecting mirror 440 are arranged at positions symmetrical to the parabola axis. Further, the plane reflecting mirror 160 and the plane reflecting mirror 460 are arranged at positions symmetrical to the parabola axis. Note that the structure of a casing accommodating these components of the second optical system 402 may be structure resulted when the casing illustrated in FIG. 5 of the second example embodiment is inverted in the y direction, for example.

When emitted from the sensor unit 130 in the left-under direction in FIG. 17, light enters the reflective surface 440a. The light reflected by the reflective surface 440a is parallel to the parabola axis, as illustrated by the light paths L9 and L10. The light reflected by the reflective surface 440a is emitted out of the second optical system 402, as illustrated in FIG. 18.

Herein, both of the reflective surface 140a of the parabolic reflecting mirror 140 and the reflective surface 440a of the parabolic reflecting mirror 440 are provided so as to be absent at the parabola vertex. This configuration corresponds to the diagram of light paths illustrated in FIG. 10. Accordingly, as described in the illustration of FIG. 8 to FIG. 10, since reflected light at the parabola vertex does not re-enter the sensor unit 130, it is possible to suppress a reduction in detection accuracy. Therefore, also in the present example embodiment, the ranging apparatus 400 having improved detection accuracy can be provided in the same manner as in the second example embodiment. Furthermore, in the present example embodiment, it is possible to broaden a scan range of emission light by using two optical systems.

### Seventh Example Embodiment

Next, as a seventh example embodiment of the present invention, a configuration example of a ranging apparatus having a logarithm spiral reflecting mirror and two parabolic reflecting mirrors will be described. Description of components common to those in the example embodiments described above will be omitted or simplified.

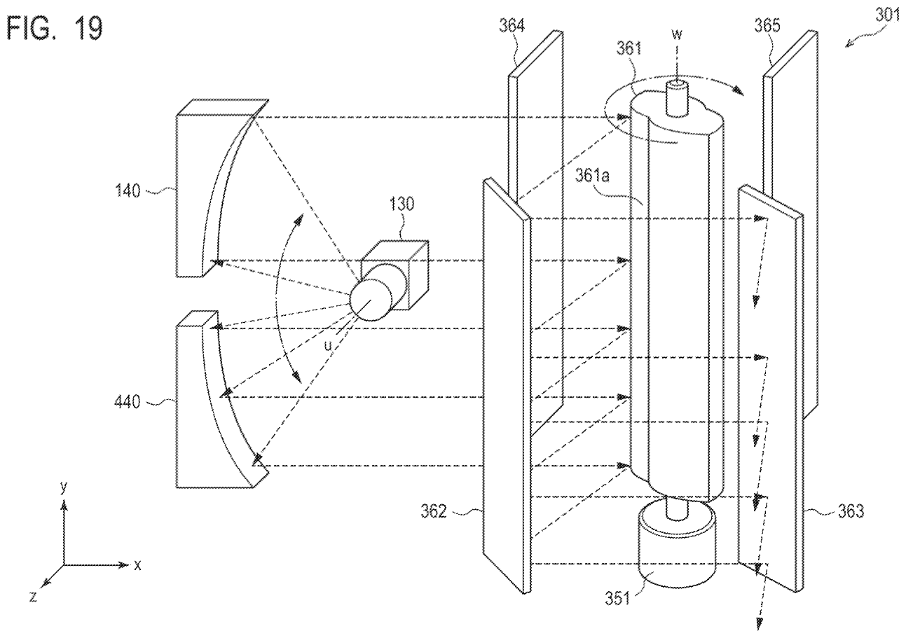

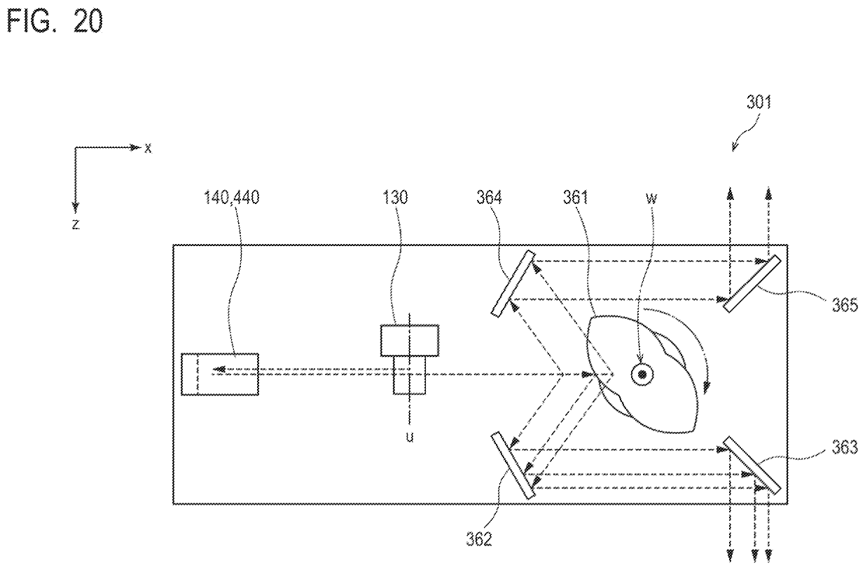

FIG. 19 is a schematic perspective view illustrating the structure of the ranging apparatus 301 according to the seventh example embodiment. FIG. 20 is a schematic diagram illustrating the structure of the ranging apparatus 301 when viewed from the top. The ranging apparatus 301 of the present example embodiment is a ranging apparatus in which, in the ranging apparatus 300 in the fifth example embodiment, the parabolic reflecting mirror 340 is replaced with the parabolic reflecting mirror 140 and the parabolic reflecting mirror 440 of the sixth example embodiment. The same advantageous effects as those in the fifth example embodiment are obtained also in the present example embodiment. Further, in the present example embodiment, the structure of the parabolic reflecting mirrors is simplified compared to the case of the fifth example embodiment.

### Eighth Example Embodiment

Next, as an eighth example embodiment of the present invention, a configuration example of a ranging apparatus having a plurality of LiDAR devices each formed of a Micro Electro Mechanical System (MEMS) will be described. Description of components common to those in the example embodiments described above will be omitted or simplified.

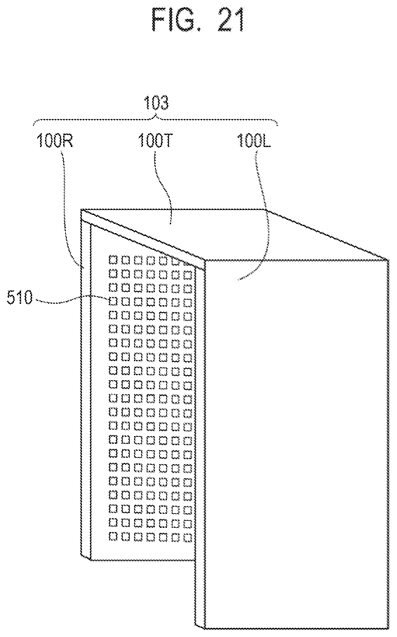

FIG. 21 is a schematic perspective view illustrating the structure of the gate apparatus 103 according to the eighth example embodiment. Each of the ranging apparatuses 100T, 100L, and 100R in the gate apparatus 103 of the present example embodiment has a plurality of LiDAR devices 510 each formed of a MEMS including MEMS structure such as a MEMS mirror. The LiDAR device 510 is configured to be able to perform a scan with emitted light by using a MEMS mirror, for example.

The plurality of LiDAR devices 510 in the ranging apparatus 100R are arranged in a matrix along the emission surface of the ranging apparatus 100R, as illustrated in FIG. 21, for example. Each of the plurality of LiDAR devices 510 acquires distance information on distances from the ranging apparatus 100R to the load G passing through the gate apparatus 103 in a predetermined range. Thereby, the ranging apparatus 100R can acquire distance distribution information indicating the distribution of distances from the ranging apparatus 100R to the load G passing through the gate apparatus 103 across the reference surface parallel to the emission surface. Note that a plurality of LiDAR devices 510 in other ranging apparatuses 100T and 100L are also configured in the same manner as in the case of the ranging apparatus 100R.

### Ninth Example Embodiment

Next, as a ninth example embodiment of the present invention, a case where the gate apparatus 103 in the gate system 2 is installed in the vehicle berth B will be described. Description of components common to those in the example embodiments described above will be omitted or simplified.

As described above, each of the gate apparatus 103, the control apparatus 200, and the notification apparatus 600 included in the gate system 2 is not necessarily required to be mounted on the vehicle 40. For example, the gate apparatus 103 may be installed in the vehicle berth B where the load G is loaded into the vehicle 40.

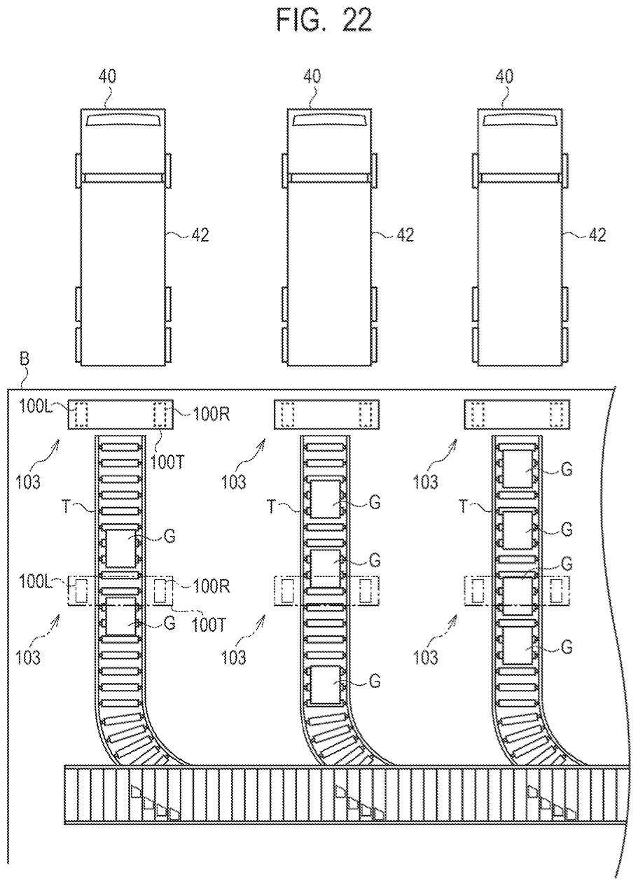

FIG. 22 is a schematic top view illustrating the arrangement of gate apparatuses 103 according to the present example embodiment. The gate apparatuses 103 according to the present example embodiment are installed on the edge of the vehicle berth B where the loads G are loaded into the cargo spaces 42 of the vehicles 40, for example. Each vehicle 40 to be loaded with the load G is stopped with the rear side of the cargo space 42 facing the edge of the vehicle berth B. Each end of the transport paths T on which the loads G to be loaded into the vehicles 40 are transported is located to the opposite side of the gate apparatus 103 from the vehicle 40 side. On the edge of the vehicle berth B on which the gate apparatuses 103 are installed, each load G that has passed through the gate apparatus 103 is loaded from the loading port at the rear part of the cargo space 42 of the vehicle 40.

Further, the gate apparatus 103 may be installed over the transport path T on which the loads G sorted to be loaded into a particular vehicle 40 are transported, for example, in addition to the above.

As described in the present example embodiment, the gate apparatus 103 may be installed to a place other than the vehicle 40. Further, the control apparatus 200 and the notification apparatus 600 may also be installed to a predetermined place in the vehicle berth B in a similar manner to the gate apparatus 103.

### Another Example Embodiment

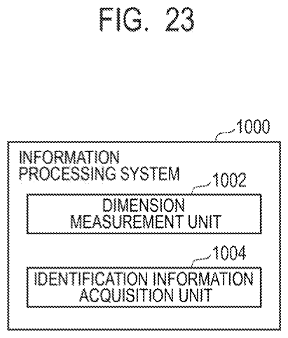

The gate system that is an information processing system described in the above example embodiments may be configured as illustrated in FIG. 23 according to yet another example embodiment. FIG. 23 is a block diagram illustrating a configuration of the information processing system according to another example embodiment.

As illustrated in FIG. 23, an information processing system 1000 according to another example embodiment has a dimension measurement unit 1002 that measures three-dimensional dimensions of a load to be loaded into a vehicle. Further, the information processing system 1000 has an identification information acquisition unit 1004 that acquires identification information on a load based on a signal read from the load in measurement of the three-dimensional dimensions.

According to the information processing system 1000 of another example embodiment, high working efficiency can be realized in loading of loads into a vehicle.

### Modified Example Embodiment

Note that all the above example embodiments are mere illustration of embodied examples in implementing the present invention, and the technical scope of the present invention is not to be construed in a limiting sense by these example embodiments. That is, the present invention can be implemented in various forms without departing from the technical concept or the primary feature thereof. For example, it should be understood that an example embodiment in which a part of the configuration of any of the example embodiments is added to another example embodiment or an example embodiment in which a part of the configuration of any of the example embodiments is replaced with a part of the configuration of another example embodiment is also one of the example embodiments to which the present invention is applicable.

For example, although the case where the vehicle 40 is a goods vehicle such as a truck has been described as an example in the above example embodiment, the case is not limited thereto. The vehicle 40 may be a railway vehicle such as a goods train, for example, other than a goods vehicle.

Further, the scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. The control apparatus 200 and the management server 30 can each function as such a computer. Further, each of the example embodiments includes not only the storage medium in which the computer program described above is stored but also the computer program itself.

As the storage medium, for example, a floppy (registered trademark) disk, a hard disk, an optical disk, a magneto-optical disk, a compact disk-read only memory (CD-ROM), a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

The whole or part of the example embodiments disclosed above can be described as, but not limited to, the following supplementary notes.

### (Supplementary Note 1)

An information processing system comprising:

a dimension measurement unit that measures three-dimensional dimensions of a load; and

an identification information acquisition unit that acquires identification information on the load based on a signal read from the load in measurement of the three-dimensional dimensions.

### (Supplementary Note 2)

The information processing system according to supplementary note 1, wherein the dimension measurement unit measures the three-dimensional dimensions when the load is loaded into a vehicle.

### (Supplementary Note 3)

The information processing system according to supplementary note 1 or 2, wherein the dimension measurement unit includes a ranging unit that acquires a distribution of distances to the load.

### (Supplementary Note 4)

The information processing system according to supplementary note 3, wherein the ranging unit acquires a two-dimensional distribution of the distances.

### (Supplementary Note 5)

The information processing system according to supplementary note 3 or 4, wherein the ranging unit emits light to the load and acquires the distribution of the distances based on reflected light from the load.

### (Supplementary Note 6)

The information processing system according to supplementary note 5, wherein the ranging unit performs a scan with parallel light rays as the light emitted to the load.

### (Supplementary Note 7)

The information processing system according to any one of supplementary notes 3 to 6, wherein the ranging unit acquires the distribution of the distances to the load from a plurality of directions.

### (Supplementary Note 8)

The information processing system according to any one of supplementary notes 3 to 7,

wherein the ranging unit reads a code symbol displayed on the load, and

wherein the identification information acquisition unit acquires the identification information based on the signal read from the code symbol.

### (Supplementary Note 9)

An information processing method comprising: measuring three-dimensional dimensions of a load; and

acquiring identification information on the load based on a signal read from the load in measurement of the three-dimensional dimensions.

### (Supplementary Note 10)

A storage medium storing a program that causes a computer to perform:

causing a dimension measurement unit to measure three-dimensional dimensions of a load; and

acquiring identification information on the load based on a signal read from the load in measurement of the three-dimensional dimensions.

As described above, while the present invention has been described with reference to the example embodiments, the present invention is not limited to the example embodiments described above. Various modifications that may be understood by those skilled in the art within the scope of the present invention can be made to the configuration and the detail of the present invention.

This application is based upon and claims the benefit of priority from Japanese Patent Application No. 2018-213599, filed on Nov. 14, 2018, the disclosure of which is incorporated herein in its entirety by reference.

### REFERENCE SIGNS LIST

1 loading management system
2 gate system
30 management server
40 vehicle
100, 100T, 100L, 100R, 101, 102, 300, 301, 400 ranging apparatus
103 gate apparatus
200 control apparatus
600 notification apparatus
700 code scanner

What is claimed is:

1. An information processing system comprising:
a dimension measurement unit that measures three-dimensional dimensions of a load; and
an identification information acquisition unit that acquires identification information on the load based on a signal read from the load in measurement of the three-dimensional dimensions.

2. The information processing system according to claim 1, wherein the dimension measurement unit measures the three-dimensional dimensions when the load is loaded into a vehicle.

3. The information processing system according to claim 1, wherein the dimension measurement unit includes a ranging unit that acquires a distribution of distances to the load.

4. The information processing system according to claim 3, wherein the ranging unit acquires a two-dimensional distribution of the distances.

5. The information processing system according to claim 3, wherein the ranging unit emits light to the load and acquires the distribution of the distances based on reflected light from the load.

6. The information processing system according to claim 5, wherein the ranging unit performs a scan with parallel light rays as the light emitted to the load.

7. The information processing system according to claim 3, wherein the ranging unit acquires the distribution of the distances to the load from a plurality of directions.

8. The information processing system according to claim 3, wherein the ranging unit reads a code symbol displayed on the load, and wherein the identification information acquisition unit acquires the identification information based on the signal read from the code symbol.

9. An information processing method comprising:
measuring three-dimensional dimensions of a load; and
acquiring identification information on the load based on a signal read from the load in measurement of the three-dimensional dimensions.

10. A non-transitory storage medium storing a program that causes a computer to perform:
causing a dimension measurement unit to measure three-dimensional dimensions of a load; and
acquiring identification information on the load based on a signal read from the load in measurement of the three-dimensional dimensions.
